(19) United States
(12) Patent Application Publication
(10) Pub. No.: US 2025/0123128 A1
(43) Pub. Date: Apr. 17, 2025

(54) PINCH DETECTION USING REAL-TIME OPTICAL TIME DOMAIN REFLECTOMETRY

(71) Applicant: EXFO Inc., Quebec (CA)

(72) Inventors: Vincent DEMERS-CARPENTIER, Quebec (CA); Eric THOMASSIN, Quebec (CA); Ines BAYOUDH EP BELGHITH, Levis (CA); Rahma HAMMAMI, Quebec (CA)

(21) Appl. No.: 18/891,340

(22) Filed: Sep. 20, 2024

Related U.S. Application Data
(60) Provisional application No. 63/589,794, filed on Oct. 12, 2023.

(51) Int. Cl. G01D 5/353

(52) U.S. Cl. CPC G01D 5/35367

(57) ABSTRACT

There is provided an OTDR method of assisting a user in finding a temporary event along an optical fiber link using an Optical Time Domain Reflectometer (OTDR). The method comprises: performing at least one OTDR acquisition toward the optical fiber link to obtain a baseline OTDR trace, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link; repeating OTDR acquisitions in real-time to obtain real-time OTDR traces; and for each new OTDR acquisition, comparing the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

### TECHNICAL FIELD

The present description generally relates to Optical Time-Domain Reflectometry (OTDR), and more particularly to real-time acquisition using an Optical Time-Domain Reflectometer.

### BACKGROUND

One function of OTDR instruments is the real-time acquisition mode. The real-time measurements are not saved and are noisier given the much lower acquisition time, but they allow experienced users to make quick assessments that are very useful in certain situations. In diagnosis, some defects along an optical fiber link can be uncovered just by looking at real-time OTDR traces for a short time such as 2 seconds instead of waiting for a full acquisition and analysis (which may take about 30 seconds).

However, not all technicians are trained to interpret OTDR traces. The wealth of information contained in an OTDR trace can prove overwhelming to low-level technicians, which are more and more common. This effect is compounded by the small screen present in some handheld OTDR instruments or optical multimeters (such as EXFO's OX1 product), which do not allow to suitably display OTDR traces.

Pinch detection is one of the most common uses of the real-time OTDR mode and it can serve a variety of workflows. A user may connect the OTDR instrument to one end of an optical fiber link with the need to identify the optical fiber at an access port down the line (e.g., a few kilometers away). Optical fibers can get tangled up and a technician needs to be sure he has found the proper optical fiber before proceeding with his work. Alternatively, a technician may know which optical fiber is the correct one but wants to know where he is currently located along that optical fiber relative to a problematic element. Because of the slack given to optical fibers, optical distance never fully corresponds to geographical distance. Therefore, a user may need a quick way to make sure that he is at the right position before proceeding with his work.

In real-time OTDR mode, the user may use pinching to confirm he is on the right optical fiber or where he is along that optical fiber by pinching the fiber lightly, which induces a small temporary loss, and detecting the induced deformation along the OTDR trace in real-time mode. This is a common way to work but requires a trained technician to look at the real-time trace to recognize a deformation of the trace.

There therefore remains a need for a method to assist OTDR users in finding a pinch or other temporary event along an optical fiber (causing a temporary deformation of an OTDR trace) in real-time OTDR mode.

### SUMMARY

The present invention seeks to eliminate, or at least mitigate, some disadvantages of the prior art, or at least provide an alternative.

There is provided an OTDR method, an OTDR system and a non-transitory computer-readable storage medium for assisting a user in finding a temporary event along an optical fiber link using an Optical Time Domain Reflectometer (OTDR). The method comprises: performing at least one OTDR acquisition toward the optical fiber link to obtain a baseline OTDR trace, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link; repeating OTDR acquisitions in real-time to obtain real-time OTDR traces; and for each new OTDR acquisition, comparing the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

In accordance with one aspect, there is provided an OTDR method of assisting a user in finding a temporary event along an optical fiber link using an Optical Time Domain Reflectometer (OTDR), the method comprising:
performing at least one OTDR acquisition toward the optical fiber link to obtain a baseline OTDR trace, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link;
repeating OTDR acquisitions in real-time to obtain real-time OTDR traces; and
for each new OTDR acquisition, comparing the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

In accordance with another aspect, there is provided an Optical Time Domain Reflectometer (OTDR) system for assisting a user in finding a temporary event along an optical fiber link, the OTDR system comprising:
an OTDR acquisition device connectable toward an end of the optical fiber link for performing at least one OTDR acquisition toward an optical fiber link under test, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link under test, and wherein OTDR acquisitions are repeated in real-time to obtain real-time OTDR traces; and
a processing unit receiving said real-time trace and configured to:
   for each new OTDR acquisition, compare the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

In accordance with yet another aspect, there is provided a non-transitory computer-readable storage medium comprising instructions that, when executed, cause a processor to perform the steps of:
receiving data derived from at least one OTDR acquisition performed toward an optical fiber link under test, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link under test, and wherein OTDR acquisitions are repeated in real-time to obtain real-time OTDR traces; and
for each new OTDR acquisition, comparing the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

Further features and advantages of the present invention will become apparent to those of ordinary skill in the art upon reading of the following description, taken in conjunction with the appended drawings.

The following description is provided to gain a comprehensive understanding of the methods, apparatus and/or systems described herein. Various changes, modifications, and equivalents of the methods, apparatuses and/or systems described herein will suggest themselves to those of ordinary skill in the art. Description of well-known functions and structures may be omitted to enhance clarity and conciseness.

Although some features may be described with respect to individual exemplary embodiments, aspects need not be limited thereto such that features from one or more exemplary embodiments may be combined with other features from one or more other exemplary embodiments.

### BRIEF DESCRIPTION OF THE DRAWINGS

FIG. 1 is a graph representing the pinch detection factors used during the detection process, in accordance with one embodiment.

FIG. 2 is a graph representing the pinch detection steps, in accordance with one embodiment.

FIG. 3A is a graph representing a first example of pinch detection resulting from a link under test that is about 27 km long and wherein a pinch is detected at a position of 4614 m along the link under test.

FIG. 3B is a graph representing a second example of pinch detection resulting from the same link under test that is about 27 km long and wherein a pinch is detected at a position of 26665 m along the link under test.

FIG. 4 is a block diagram illustrating an example architecture of an OTDR device which may embody the herein-described pinch detection function.

FIG. 5 is a block diagram illustrating an example architecture of an OTDR acquisition device of the OTDR device of FIG. 4.

It will be noted that throughout the drawings, like features are identified by like reference numerals. In the following description, similar features in the drawings have been given similar reference numerals and, to not unduly encumber the figures, some elements may not be indicated on some figures if they were already identified in a preceding figure. It should be understood herein that elements of the drawings are not necessarily depicted to scale, since emphasis is placed upon clearly illustrating the elements and structures of the present embodiments. Some mechanical or other physical components may also be omitted in order to not encumber the figures.

### DETAILED DESCRIPTION

There is provided an automated real-time pinch finder function made to replace the result an expert would obtain with a real-time OTDR.

OTDR is a diagnostic technique for optical fiber links where a test signal in the form of light pulses is launched in the optical fiber link under test and the return light signal, arising from backscattering and reflections along the link, is detected. Herein, the process of launching a test signal and acquiring the return light signal to obtain therefrom an OTDR trace is referred to as an “OTDR acquisition”. The acquired power level of the return light signal as a function of time is referred to as an “OTDR trace” or a “reflectometric trace”, where the time scale is representative of distance between the OTDR acquisition device and a point along the fiber link.

In the following description, techniques that are generally known to one skilled in the art of OTDR measurement and OTDR trace processing and analysis will not be explained or detailed and in this respect, the reader is referred to available literature in the art. Such techniques that are considered to be known include, e.g., signal processing methods for identifying and characterizing events from an OTDR trace.

Each OTDR acquisition is understood to refer to the actions of propagating a test signal comprising one or more test light pulses having the same pulse width in the optical fiber link, and detecting corresponding return light signal from the optical fiber link as a function of time. A test light-pulse signal travelling along the optical fiber link will return towards its point of origin either through (distributed) backscattering or (localized) reflections. The acquired power level of the return light signal as a function of time is referred to as the OTDR trace, where the time scale is representative of distance between the OTDR acquisition device and a point along the optical fiber link. Light acquisitions may be repeated with varied pulse width values to produce a separate OTDR trace for each test pulse width.

One skilled in the art will readily understand that in the context of OTDR methods and systems, each light acquisition generally involves propagating a large number of substantially identical light pulses in the optical fiber link and averaging the results. In this case, the result obtained from averaging will herein be referred to as an OTDR trace. It will also be understood that other factors may need to be controlled during the light acquisitions or from one light acquisition to the next, such as gain settings, pulse power, etc. as is well known to those skilled in the art.

“Backscattering” refers to Rayleigh scattering occurring from the interaction of the travelling light with the optical fiber media all along the fiber link, resulting in a generally sloped background light (in logarithmic units, i.e. dB, on the ordinate) on the OTDR trace, whose intensity disappears at the end of the range of the travelling pulse. “Events” along the fiber will generally result in a more localized drop of the backscattered light on the OTDR trace, which is attributable to a localized loss, and/or in a localized reflection peak. It will be understood that an “event” characterized by the OTDR method described herein may be generated by any perturbation along the fiber link which affects the returning light. Typically, an event may be generated by an optical fiber splice along the fiber link, which is characterized by a localized loss with little or no reflection. Mating connectors can also generate events that typically present reflectance, although these may be impossible to detect in some instances. OTDR methods and systems may also provide for the identification of events such as a fiber breakage, characterized by substantial localized loss and, frequently, a concomitant reflection peak, as well as loss resulting from a bend in the fiber. Finally, any other component along the fiber link may also be manifest as an “event” generating localized loss.

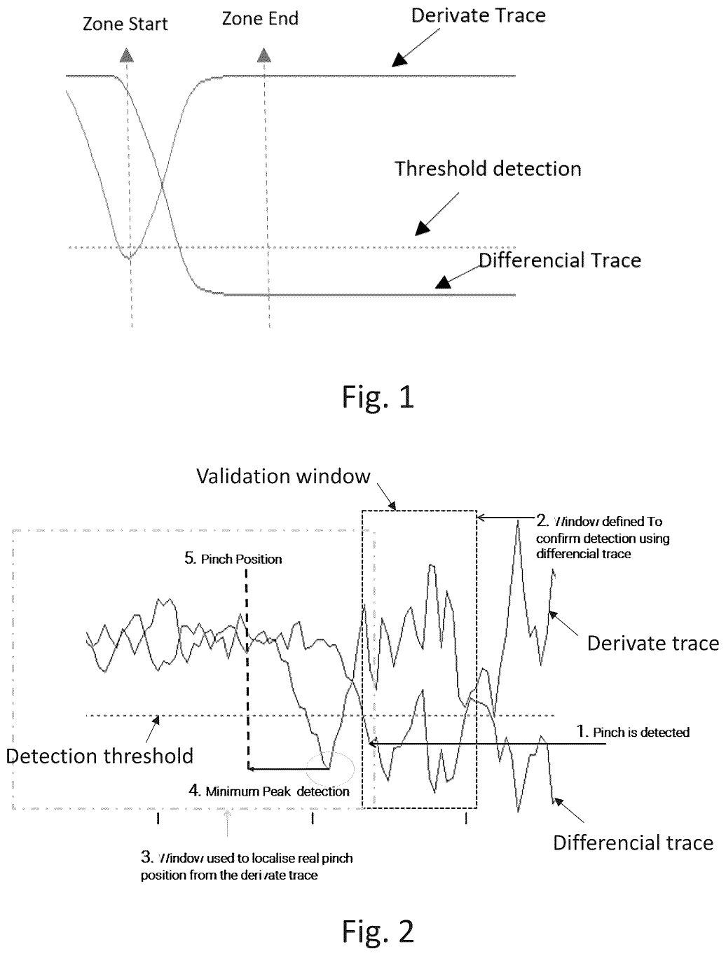

Now referring to FIG. 1, the pinch finder method is described. Put simply, the pinch finder function may choose the pulse width and wavelength to be used for the OTDR acquisitions based on the loss and length of the optical fiber link under test. It then detects and localizes the loss associated with a user-induced pinch by comparing the OTDR trace of the undisturbed fiber with the real-time acquisition of the pinched fiber. A pinch on the fiber will result in a localized and transient loss that is detected in real-time mode by comparing the baseline (without the pinch) and the real-time trace taken while pinching. The presence of the pinch may then be detected by using the difference between the baseline trace and the real-time trace (difference trace), using the derivative of the difference trace or a combination of both. A detection threshold may be chosen automatically based on the expected local noise level (extrapolated from the position, pulse, refresh rate and expected loss). Similarly, the position of the pinch along the optical fiber link may be estimated using the difference trace, the derivate trace or a combination of both. The position of the pinch is then communicated in real-time to the user via a simplified interface.

In a first embodiment, the user can use the pinch finder function without any prior knowledge of the fiber under test. The invention first carries out a short routine to determine within a few seconds the link length and total loss. The pinch finder function then solves an equation to choose the smallest possible pulse that allows an acquisition rate judged acceptable in a real-time mode (1-4 Hz) and a noise level along the whole fiber permitting the detection of a localized loss of the size of the expected loss of a pinch (i.e., about 1 dB). The wavelength may be chosen automatically by the pinch finder function so as to maximize the effect of a pinch, typically the longest wavelength available.

The pinch finder function then acquires a baseline representing the undisturbed fiber. Optimally, the acquisition time for the baseline is several times the real-time refresh rate since the Signal-to-Noise Ratio on the differential trace (real-time vs baseline) will propagate the noise level on the baseline.

The real-time acquisition then starts automatically. Each real-time trace is used to calculate a differential trace (real-time vs baseline).

In one embodiment, the derivative of the differential trace is then used to detect a pinch (derivate trace). A detection threshold is calculated from the expected loss of a pinch above the expected noise level. It is noted that a spatial filtration of the differential trace may be applied using a kernel smaller than the pulse width without major impact on the detection level since a real pinch signature would get convoluted to the pulse shape. A pinch is detected when the derivate trace crosses the detection threshold. The pinch finder function then notifies the user, through a sound and a visual cue. The position of the event may be shown in a simplified interface from the start of the fiber.

It was found that detection based on the derivate trace may not be robust enough in case of noisy traces. Therefore, in another embodiment, the differential trace is used to detect a pinch. A pinch is detected when the differential trace crosses the detection threshold.

In one example implementation, the detection threshold may be defined as below:

$$DetectionThreshold ( x ) = max ( ( deltaDn - min Loss ) / 2 , - min Loss ) - 10 / samples ( x )$$

wherein deltaDn represents the delta noise level, minLoss is the minimal loss to be detected and samples(x) is the signal samples.

In some embodiments, the pinch detection process if further refined to avoid false detection particularly into noisy zones. The pinch detection process is triggered upon the differential trace crossing the detection threshold. However, other criteria may be considered before confirming a pinch.

For example, a validation window (green window in FIG. 2) may be used to confirm a pinch. In the case illustrated in FIG. 2, the validation window is set from the position where the differential trace crosses the detection threshold to a given distance beyond this position. Then, a pinch detection is confirmed only if at least 50% of samples included into the validation window satisfies the detection condition (i.e., the differential value is below the detection threshold). Using such a verification, the detection may be significantly improved.

After confirming a pinch detection, the exact position of the pinch may be determined. For example, to ensure position precision, the derivate trace may be used to locate the pinch. As illustrated in FIG. 2, in one embodiment, the pinch position is estimated as the position of the minimum value of the derivate trace minus a given delta (i.e., a given distance before the minimum peak). The delta position accounts for the pulse width and may be set as a function of the pulse width used for the OTDR acquisitions.

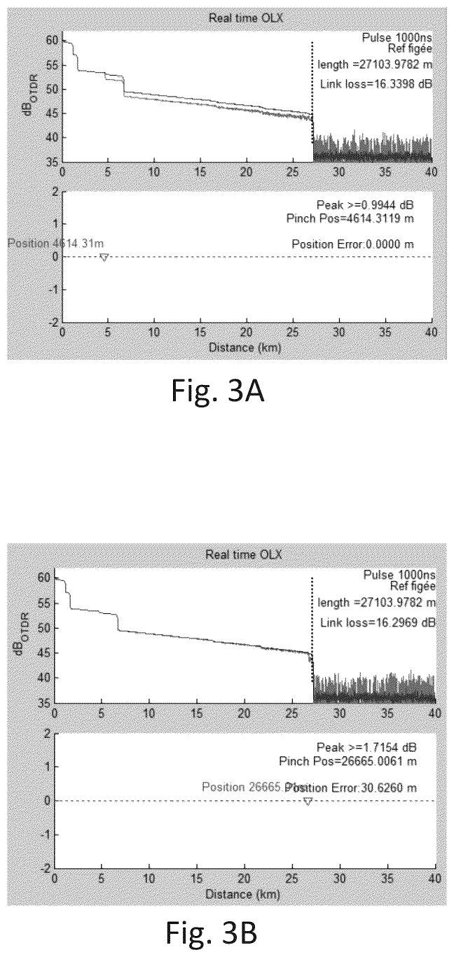

FIGS. 3A and 3B illustrate examples of pinch detection using different positions. In both examples, the link under test is about 27 km long and has total loss of 16.29 dB. The acquisition process selects a pulse width of 1000 ns to perform the acquisition at the wavelength of 1550 nm and a range of 40 km.

In the example of FIG. 3A, a pinch is detected at a position of 4614 m along the link under test whereas in the example of FIG. 3B, a pinch is detected at 26665 m.

Spatial filtration of the differential trace is possible using a kernel smaller than the pulse width without major impact on the detection level since a real pinch signature would get convoluted to the pulse shape. An adaptative acquisition may be also addressed to enhance detection. In fact, giving information about pinch position and link loss, the pulse width and range can be adjusted to reduce noise around detection zone.

In a second embodiment, the pinch finder function is especially tailored to a use case where the user needs to locate a specific element on a pre-characterized fiber. In this case, the acquisition parameters are based on the known loss and length of the fiber, shaving several second from the pre-acquisition routine. This is an interesting improvement that consists of using context from a previous measurement to allow an optimization of real-time measurements. Real-time measurements when carried out with conventional OTDRs are agnostic to the previous fiber characterization and shift this work on a trained user. A quick validation of the position of the end of fiber on the baseline may also be used to flag instances where the pre-characterized fiber differs from the fiber under test. The pinch detection may proceed in the same way.

In one use case, the pinch finder function may be used to locate a specific target element along the optical fiber link under test. For example, the target element may consist of a failing connector to be repaired or replaced. When a pinch is detected, the position of the pinch may be indicated in the user interface, in relative to the target element along the optical fiber link under test, so as to help the user to find a physical location of the target element.

Variations to the herein described embodiments are envisaged. For example, in another embodiment, instead of acquiring a baseline before launching real-time acquisition, in another embodiment, the baseline may be a rolling average several seconds before the latest real-time acquisition. This allows continuous measurement and the rapid switch from one fiber to the next, but may come with the drawback that the user may have to wait several seconds after pinching the fiber, creating a lag that could prove confusing to the user.

Pinching the fiber has several drawbacks that may be addressed with a specialized tool. Pinching a fiber too hard may result in damage to the fiber. Also, the intensity of a hand-made pinch can vary a lot and therefore be harder to detect. The use of a pinching instrument that produces a reproductible pinch prevents accidental damage to the fiber and allows for a predictable induced loss. Such predictable loss may in turn be used to better discriminate pinch from other events that may cause false-positives.

### Example of OTDR Device Architecture

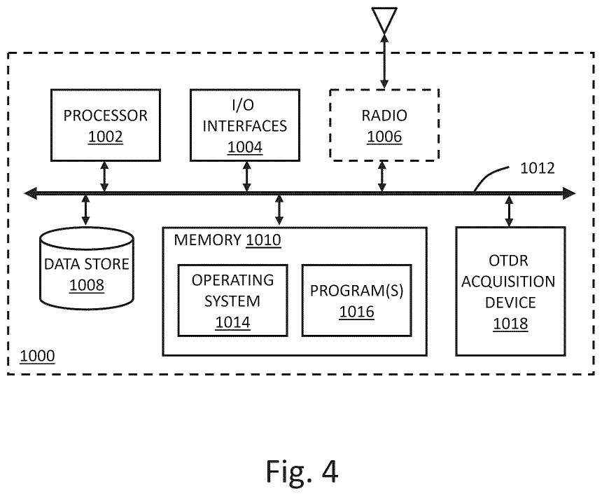

FIG. 4 is a block diagram of an OTDR device 1000 which may embody the pinch finder function as described herein. The OTDR device 1000 may comprise a digital device that, in terms of hardware architecture, generally includes a processor 1002, input/output (I/O) interfaces 1004, an optional radio 1006, a data store 1008, a memory 1010, as well as an optical test device including an OTDR acquisition device 1018. It should be appreciated by those of ordinary skill in the art that FIG. 4 depicts the OTDR device 1000 in a simplified manner, and a practical embodiment may include additional components and suitably configured processing logic to support known or conventional operating features that are not described in detail herein. A local interface 1012 interconnects the major components. The local interface 1012 can be, for example, but not limited to, one or more buses or other wired or wireless connections, as is known in the art. The local interface 1012 can have additional elements, which are omitted for simplicity, such as controllers, buffers (caches), drivers, repeaters, and receivers, among many others, to enable communications. Further, the local interface 1012 may include address, control, and/or data connections to enable appropriate communications among the aforementioned components.

The processor 1002 is a hardware device for executing software instructions. The processor 1002 may comprise one or more processors, including central processing units (CPU), auxiliary processor(s) or generally any device for executing software instructions. When the OTDR device 1000 is in operation, the processor 1002 is configured to execute software stored within the memory 1010, to communicate data to and from the memory 1010, and to generally control operations of the OTDR device 1000 pursuant to the software instructions. In an embodiment, the processor 1002 may include an optimized mobile processor such as optimized for power consumption and mobile applications. The I/O interfaces 1004 can be used to receive user input from and/or for providing system output. User input can be provided via, for example, a keypad, a touch screen, a scroll ball, a scroll bar, buttons, barcode scanner, and the like. System output can be provided via a display device such as a liquid crystal display (LCD), touch screen, and the like, via one or more LEDs or a set of LEDs, or via one or more buzzer or beepers, etc. The I/O interfaces 1004 can be used to display a graphical user interface (GUI) that enables a user to interact with the OTDR device 1000 and/or output at least one of the values derived by the OTDR analyzing module.

The radio 1006, if included, may enable wireless communication to an external access device or network. Any number of suitable wireless data communication protocols, techniques, or methodologies can be supported by the radio 1006, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); NarrowBand Internet of Things (NB-IoT); Long Term Evolution Machine Type Communication (LTE-M); magnetic induction; satellite data communication protocols; and any other protocols for wireless communication. The data store 1008 may be used to store data, such as OTDR traces and OTDR measurement data files. The data store 1008 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 1008 may incorporate electronic, magnetic, optical, and/or other types of storage media.

The memory 1010 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 1010 may incorporate electronic, magnetic, optical, and/or other types of storage media. Note that the memory 1010 may have a distributed architecture, where various components are situated remotely from one another, but can be accessed by the processor 1002. The software in memory 1010 can include one or more computer programs, each of which includes an ordered listing of executable instructions for implementing logical functions. In the example of FIG. 4, the software in the memory 1010 includes a suitable operating system (O/S) 1014 and computer programs 1016. The operating system 1014 essentially controls the execution of other computer programs and provides scheduling, input-output control, file and data management, memory management, and communication control and related services. The program(s) 1016 may include various applications, add-ons, etc. configured to provide end-user functionality with the OTDR device 1000. For example, example programs 1016 may include a web browser to connect with a server for transferring OTDR measurement data files, a dedicated OTDR application configured to control OTDR acquisitions by the OTDR acquisition device 1018, set OTDR acquisition parameters, analyze OTDR traces obtained by the OTDR acquisition device 1018 and display a GUI related to the OTDR device 1000. For example, the dedicated OTDR application may embody an OTDR analysis module configured to analyze acquired OTDR traces in order to characterize the optical fiber link under test, and produce OTDR measurement data files.

It is noted that, in some embodiments, the I/O interfaces 1004 may be provided via a physically distinct mobile device (not shown), such as a handheld computer, a smartphone, a tablet computer, a laptop computer, a wearable computer or the like, e.g., communicatively coupled to the OTDR device 1000 via the radio 106. In such cases, at least some of the programs 1016 may be located in a memory of such a mobile device, for execution by a processor of the physically distinct device. The mobile may then also include a radio and be used to transfer OTDR measurement data files toward a remote test application residing, e.g., on a server.

It should be noted that the OTDR device shown in FIG. 4 is meant as an illustrative example only. Numerous types of computer systems are available and can be used to implement the OTDR device.

### Example of OTDR Acquisition Device Architecture

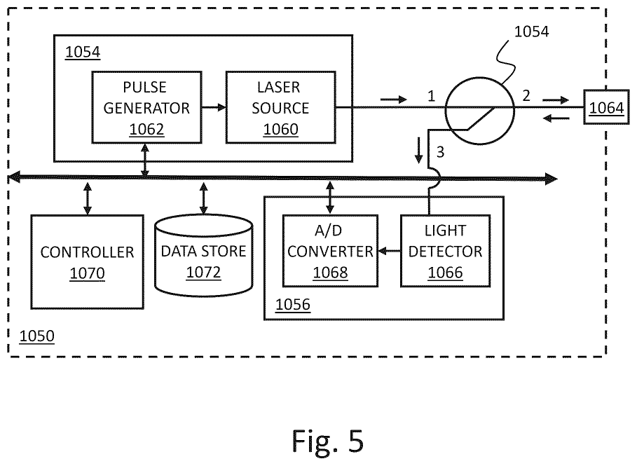

FIG. 5 is a block diagram an embodiment of an OTDR acquisition device 1050 which may embody the OTDR acquisition device 1018 of the OTDR device 1000 of FIG. 4.

The OTDR acquisition device 1050 is connectable toward the tested optical fiber link via an output interface 1064, for performing OTDR acquisitions toward the optical fiber link. The OTDR acquisition device 1050 comprises conventional optical hardware and electronics as known in the art for performing OTDR acquisitions over an optical fiber link.

The OTDR acquisition device 1050 comprises a light generating assembly 1054, a detection assembly 1056, a directional coupler 1058, as well as a controller 1070 and a data store 1072.

The light generating assembly 1054 is embodied by a laser source 1060 driven by a pulse generator 1062 to generate the OTDR test signal comprising test light pulses having desired characteristics. As known in the art, the light generating assembly 1054 is adapted to generate test light pulses of varied pulse widths, repetition periods and optical power through a proper control of the pattern produced by the pulse generator 1062. One skilled in the art will understand that it may be beneficial or required by the application to perform OTDR measurements at various different wavelengths. For this purpose, in some embodiments, the light generating assembly 1054 is adapted to generate test light pulses having varied wavelengths by employing a laser source 1060 that is tunable for example. It will be understood that the light generating assembly 1054 may combine both pulse width and wavelength control capabilities. Of course, different and/or additional components may be provided in the light generating assembly, such as modulators, lenses, mirrors, optical filters, wavelength selectors and the like.

The light generating assembly 1054 is coupled to the output interface 1064 of the OTDR acquisition device 1050 through a directional coupler 1058, such as a circulator, having three or more ports. The first port is connected to the light generating assembly 1054 to receive the test light pulses therefrom. The second port is connected toward the output interface 1064. The third port is connected to the detection assembly 1056. The connections are such that test light pulses generated by the light generating assembly 1054 are coupled to the output interface 1064 and that the return light signal arising from backscattering and reflections along the optical fiber link 110 is coupled to the detection assembly 1056.

The detection assembly 1056 comprises a light detector 1066, such as a photodiode, an avalanche photodiode or any other suitable photodetector, which detects the return light signal corresponding to each test light pulse, and an analog to digital converter 1068 to convert the electrical signal proportional to the detected return light signal from analog to digital in order to allow data storage and processing. It will be understood that the detected return light signal may of course be amplified, filtered or otherwise processed before analog to digital conversion. The power level of return light signal as a function of time, which is obtained from the detection and conversion above, is referred to as one acquisition of an OTDR trace. One skilled in the art will readily understand that in the context of OTDR methods and systems, each light acquisition generally involves propagating a large number of substantially identical light pulses in the optical fiber link and averaging the results, in order to improve the Signal-to-Noise Ratio (SNR). In this case, the result obtained from averaging is herein referred to as an OTDR trace.

Of course, the OTDR acquisition device 1050 may also be used to perform multiple acquisitions with varied pulse widths to obtain a multi-pulsewidth OTDR measurement.

The OTDR acquisition device 1050, and more specifically the light generating assembly 1054 is controlled by the controller 1070. The controller 1070 is a hardware logic device. It may comprise one or more Field Programmable Gate Array (FPGA); one or more Application Specific Integrated Circuits (ASICs) or one or more processors, configured with a logic state machine or stored program instructions. When the OTDR acquisition device 1050 is in operation, the controller 1070 is configured to control the OTDR measurement process. The controller 1070 controls parameters of the light generating assembly 1054 according to OTDR acquisition parameters that are either provided by the operator of the OTDR software or otherwise determined by program(s) 1016.

The data store 1072 may be used to cumulate raw data received from the detection assembly 1056, as well as intermediary averaged results and resulting OTDR traces. The data store 1008 may include any of volatile memory elements (e.g., random access memory (RAM, such as DRAM, SRAM, SDRAM, and the like)) or the like and it may be embedded with the controller 1070 or distinct.

The OTDR traces acquired by the OTDR acquisition device 1050 may be received and analyzed by one or more of the computer programs 1016 and/or stored in data store 1008 for further processing.

It should be noted that the architecture of the OTDR acquisition device 1050 as shown in FIG. 5 is meant as an illustrative example only. Numerous types of optical and electronic components are available and can be used to implement the OTDR acquisition device.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

The embodiments described above are intended to be exemplary only and one skilled in the art will recognize that numerous modifications can be made to these embodiments without departing from the scope of the invention.

The scope of the invention is therefore intended to be limited solely by the appended claims.

1. An OTDR method of assisting a user in finding a temporary event along an optical fiber link using an Optical Time Domain Reflectometer (OTDR), the method comprising:
performing at least one OTDR acquisition toward the optical fiber link to obtain a baseline OTDR trace, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link;
repeating OTDR acquisitions in real-time to obtain real-time OTDR traces; and
for each new OTDR acquisition, comparing the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

2. The OTDR method as claimed in claim 1, wherein the temporary event comprises a pinch of the optical fiber which causes a temporary deformation of the OTDR trace.

3. The OTDR method as claimed in claim 1, further comprising estimating a position of the temporary event along the optical fiber link using at least one of a difference between the baseline OTDR trace and the real-time OTDR trace and a derivative thereof.

4. The OTDR method as claimed in claim 1, wherein the temporary event is detected using the difference between the baseline OTDR trace and the real-time OTDR trace.

5. The OTDR method as claimed in claim 1, wherein the temporary event is detected using the derivative of the difference between the baseline OTDR trace and the real-time OTDR trace.

6. The OTDR method as claimed in claim 1, wherein the temporary event is detected using a detection threshold which is chosen automatically based on the expected local noise level.

7. The OTDR method as claimed in claim 1, further comprising: outputting a user notification upon detecting a temporary event along the optical fiber link.

8. An Optical Time Domain Reflectometer (OTDR) system for assisting a user in finding a temporary event along an optical fiber link, the OTDR system comprising:
an OTDR acquisition device connectable toward an end of the optical fiber link for performing at least one OTDR acquisition toward an optical fiber link under test, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link under test, and wherein OTDR acquisitions are repeated in real-time to obtain real-time OTDR traces; and
a processing unit receiving said real-time trace and configured to:
for each new OTDR acquisition, compare the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

9. The OTDR system as claimed in claim 8, wherein the temporary event comprises a pinch of the optical fiber which causes a temporary deformation of the OTDR trace.

10. The OTDR system as claimed in claim 8, wherein said processing unit is further configured to estimate a position of the temporary event along the optical fiber link using at least one of a difference between the baseline OTDR trace and the real-time OTDR trace and a derivative thereof.

11. The OTDR system as claimed in claim 8, wherein the temporary event is detected using the difference between the baseline OTDR trace and the real-time OTDR trace.

12. The OTDR system as claimed in claim 8, wherein the temporary event is detected using the derivative of the difference between the baseline OTDR trace and the real-time OTDR trace.

13. The OTDR system as claimed in claim 8, wherein the temporary event is detected using a detection threshold which is chosen automatically based on the expected local noise level.

14. The OTDR system as claimed in claim 8, wherein said processing unit is further configured to: output a user notification upon detecting a temporary event along the optical fiber link.

15. A non-transitory computer-readable storage medium comprising instructions that, when executed, cause a processor to perform the steps of:
receiving data derived from at least one OTDR acquisition performed toward an optical fiber link under test, wherein each OTDR acquisition is performed by propagating in the optical fiber link under test, a pulsed test signal and detecting corresponding return light from the optical fiber link so as to obtain an OTDR trace representing backscattered and reflected light as a function of distance in the optical fiber link under test, and wherein OTDR acquisitions are repeated in real-time to obtain real-time OTDR traces; and
for each new OTDR acquisition, comparing the corresponding real-time OTDR trace to the baseline OTDR trace to detect a temporary deformation of the OTDR trace using at least one of a difference between the baseline OTDR trace and the real-time OTDR trace and a derivative thereof, said temporary deformation being indicative of the presence of the temporary event along the optical fiber link.

16. The non-transitory computer-readable storage medium as claimed in claim 15, wherein the temporary event comprises a pinch of the optical fiber which causes a temporary deformation of the OTDR trace.

17. The non-transitory computer-readable storage medium as claimed in claim 15, wherein said steps further comprise: estimating a position of the temporary event along the optical fiber link using at least one of a difference between the baseline OTDR trace and the real-time OTDR trace and a derivative thereof.

18. The non-transitory computer-readable storage medium as claimed in claim 15, wherein the temporary event is detected using the difference between the baseline OTDR trace and the real-time OTDR trace.

19. The non-transitory computer-readable storage medium as claimed in claim 15, wherein the temporary event is detected using the derivative of the difference between the baseline OTDR trace and the real-time OTDR trace.

20. The non-transitory computer-readable storage medium as claimed in claim 15 wherein the temporary event is detected using a detection threshold which is chosen automatically based on the expected local noise level.
